(19) United States
(12) Patent Application Publication
(10) Pub. No.: US 2009/0246397 A1
(43) Pub. Date: Oct. 1, 2009

(54) RESIST SOLUTION SUPPLY APPARATUS, RESIST SOLUTION SUPPLY METHOD, AND COMPUTER STORAGE MEDIUM

(75) Inventors: Kousuke Yoshihara, Koshi-shi (JP); Kentaro Yoshihara, Koshi-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 12/408,262

(22) Filed: Mar. 20, 2009

(30) Foreign Application Priority Data
Mar. 28, 2008 (JP) 2008-087850

(51) Int. Cl. B05D 3/00; B05C 9/00; B05C 11/00

(52) U.S. Cl. 427/445; 118/302; 118/667

(57) ABSTRACT

The present invention is a resist solution supply apparatus for supplying a resist solution to a coating nozzle for discharging the resist solution to a substrate, including: a resist solution supply source storing the resist solution therein; a supply tube for supplying the resist solution from the resist solution supply source to the coating nozzle; a heating means provided on a side of the resist solution supply source along the supply tube for heating the resist solution in the supply tube to a predetermined temperature higher than room temperature; and a cooling means provided on a side of the coating nozzle along the supply tube for cooling the resist solution in the supply tube down to room temperature.

### BACKGROUND OF THE INVENTION

1. Field of the Invention

The present invention relates to a resist solution supply apparatus for supplying a resist solution to a coating nozzle for discharging the resist solution to a substrate, for example, a semiconductor wafer or the like, a resist solution supply method, and a computer storage medium.

2. Description of the Related Art

In a photolithography step in manufacturing process of a semiconductor device, for example, a resist coating treatment of applying a resist solution onto, for example, a semiconductor wafer (hereinafter, referred to as a “wafer”) to form a resist film is performed.

In the above-described resist coating treatment, for example, a method of discharging the resist solution from a coating nozzle onto the wafer and rotating the wafer to thereby diffuse the resist solution over the wafer surface, that is, a so-called spin coating method is widely used. In this spin coating method, the temperature of the resist solution to be supplied onto the wafer needs to be regulated to a desired temperature, for example, room temperature in order to apply the resist solution in a uniform thickness on the wafer.

Hence, it has been conventionally proposed that a first temperature regulating unit is provided along a supply tube for supplying the resist solution to the coating nozzle near the coating nozzle (near an end portion of the supply tube) to regulate the temperature of the resist solution to room temperature. The first temperature regulating unit can regulate the temperature of the resist solution, for example, by flowing a temperature regulating water through the first temperature regulating unit. Further, to efficiently perform the temperature regulation of the resist solution, a second temperature regulating unit for performing temperature regulation of the resist solution is further provided near the other end portion of the supply tube to supply the temperature regulating water used in the first temperature regulating unit to the second temperature regulating unit (Japanese Patent No. 3585217).

### SUMMARY OF THE INVENTION

Incidentally, in the resist solution, a gel foreign matter (hereinafter, referred to as “resist gel”) which is polymer-based compound in the resist solution aggregated with time may be generated. However, only by the temperature regulation of the resist solution to be supplied onto the wafer to room temperature as in the prior art, the resist solution could be applied on the wafer in a uniform thickness, but the resist gel could not be removed from the resist solution. Further, it is also conceivable to provide a filter in the supply tube, but it is technically difficult to completely remove the resist gel by the existing filter because the resist gel is minute.

If the resist solution is supplied onto the wafer without removing the resist gel as described above, the resist gel remains in the resist film thereafter formed to cause defects on the wafer. Especially with miniaturization of semiconductor devices in recent years, defects due to the resist gel are prominently caused.

The present invention has been made in view of the above points, and its object is to reduce foreign matter in a resist solution to be supplied onto a substrate to thereby reduce defects on the substrate after the application of the resist solution.

To achieve the above object, the present invention is a resist solution supply apparatus for supplying a resist solution to a coating nozzle for discharging the resist solution to a substrate, including: a resist solution supply source storing the resist solution therein; a supply tube for supplying the resist solution from the resist solution supply source to the coating nozzle; a heating means provided on a side of the resist solution supply source along the supply tube for heating the resist solution in the supply tube to a predetermined temperature higher than room temperature; and a cooling means provided on a side of the coating nozzle along the supply tube for cooling the resist solution in the supply tube down to room temperature.

From the study by the inventors, it was found that the resist gel generated with time in the resist solution dissolves in the resist solution by heating the resist solution at a temperature higher than room temperature. The resist solution supply apparatus of the present invention has the heating means on the side of the resist solution supply source along the supply tube, so that the resist solution can be heated to a temperature higher than room temperature to dissolve the resist gel. This can reduce the resist gel in the resist solution to be supplied to the substrate so as to reduce defects on the substrate after the application of the resist solution. Further, since the resist solution supply apparatus of the present invention has the cooling means on the side of the coating nozzle along the supply tube, the resist solution once heated by the heating means can be cooled down to room temperature and then supplied to the coating nozzle. Thus, the resist solution can be applied on the substrate in a uniform thickness.

Note that room temperature is, for example, 23° C. Accordingly, it is only necessary that the predetermined temperature to which the resist solution is heated by the heating means is higher than 23° C., and it is more preferable that the temperature is 30° C. or higher. Further, to prevent quality deterioration of the resist solution, it is desirable that the heating of the resist solution by the heating means is performed at 50° C. or lower.

The present invention according to another aspect is a resist solution supply method of supplying a resist solution to a substrate, including the steps of: once heating the resist solution up to a predetermined temperature higher than room temperature; then cooling the resist solution down to room temperature; and then supplying the resist solution to the substrate.

The present invention according to still another aspect is a computer-readable storage medium storing a program running on a computer of a control unit for controlling a resist solution supply apparatus to cause the resist solution supply apparatus to execute the above-described resist solution supply method.

### BRIEF DESCRIPTION OF THE DRAWINGS

FIG. 1 is a plan view showing the outline of a configuration of a coating and developing treatment system equipped with a resist solution supply apparatus according to the present embodiment;

FIG. 2 is a front view of the coating and developing treatment system according to the present embodiment;

FIG. 3 is a rear view of the coating and developing treatment system according to the present embodiment;

FIG. 4 is an explanatory view of a longitudinal section showing the outline of a configuration of the resist coating unit;

FIG. 5 is an explanatory view of a transverse section showing the outline of the configuration of the resist coating unit;

FIG. 6 is an explanatory view showing the outline of a configuration of the resist solution supply apparatus;

FIG. 7 is an explanatory view showing the outline of configurations of a heater and a temperature regulator;

FIG. 8 is an explanatory view showing the outline of configurations of temperature regulating piping and a temperature regulator;

FIG. 9 is an explanatory view showing comparison between defects on wafers generated when a resist solution is supplied by a conventional method and defects on wafers generated when the resist solution is supplied by a method according to the present embodiment; and

FIG. 10 is an explanatory view showing the outline of configurations of a heater and a temperature regulator according to another embodiment.

### DETAILED DESCRIPTION OF THE INVENTION

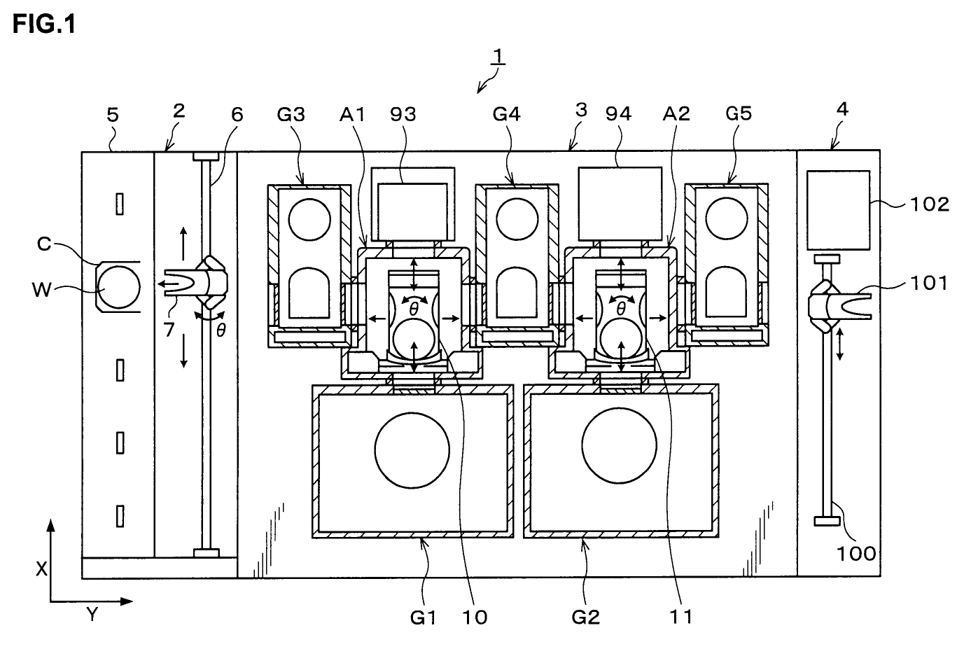

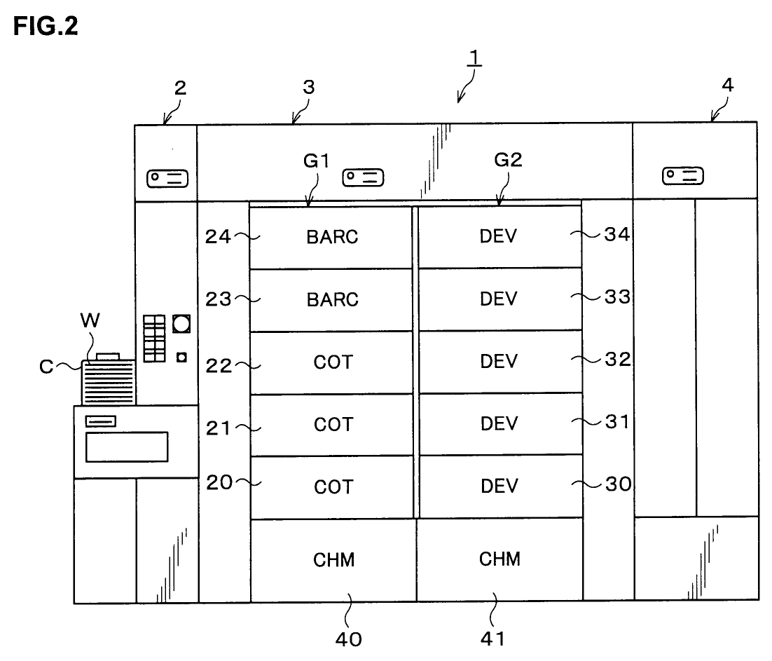

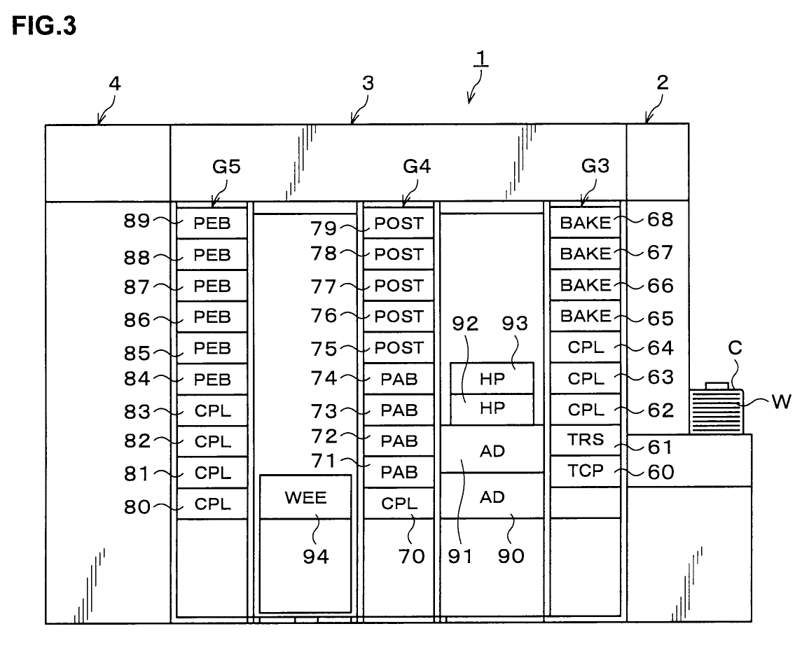

Hereinafter, a preferred embodiment of the present invention will be described. FIG. 1 is a plan view showing the outline of a configuration of a coating and developing treatment system 1 equipped with a resist solution supply apparatus according to the present embodiment, FIG. 2 is a front view of the coating and developing treatment system 1, and FIG. 3 is a rear view of the coating and developing treatment system 1.

The coating and developing treatment system 1 has, as shown in FIG. 1, a configuration in which, for example, a cassette station 2 for transferring, for example, 25 wafers W per cassette as a unit from/to the outside into/from the coating and developing treatment system 1 and transferring the wafers W into/out of a cassette C; a processing station 3 including a plurality of various kinds of processing and treatment units, which are multi-tiered, for performing predetermined processing or treatment in a manner of single wafer processing in a photolithography process; and an interface station 4 for passing the wafer W to/from an aligner (not shown) provided adjacent to the processing station 3, are integrally connected.

In the cassette station 2, a cassette mounting table 5 is provided and configured such that a plurality of cassettes C can be mounted on the cassette mounting table 5 in a line in an X-direction (a top-to-bottom direction in FIG. 1). In the cassette station 2, a wafer transfer body 7 is provided which is movable in the X-direction on a transfer path 6. The wafer transfer body 7 is also movable in a wafer-arrangement direction of the wafers W housed in the cassette C (a Z-direction; the vertical direction), and thus can selectively access the wafers W in each of the cassettes C arranged in the X-direction.

The wafer transfer body 7 is rotatable in a O-direction around the Z-axis, and can access a temperature regulating unit 60 and a transition unit 61 for passing the wafer W which are included in a later-described third processing unit group G3 on the processing station 3 side.

The processing station 3 adjacent to the cassette station 2 includes, for example, five processing unit groups G1 to G5 in each of which a plurality of processing and treatment units are multi-tiered. On the side of the negative direction in the X-direction (the downward direction in FIG. 1) in the processing station 3, the first processing unit group G1 and the second processing unit group G2 are placed in order from the cassette station 2 side. On the side of the positive direction in the X-direction (the upward direction in FIG. 1) in the processing station 3, the third processing unit group G3, the fourth processing unit group G4, and the fifth processing unit group G5 are placed in order from the cassette station 2 side. Between the third processing unit group G3 and the fourth processing unit group G4, a first transfer unit A1 is provided, and a first transfer arm 10 for supporting and transferring the wafer W is provided in the first transfer unit A1. The first transfer arm 10 can selectively access the processing and treatment units in the first processing unit group G1, the third processing unit group G3, and the fourth processing unit group G4 and transfer the wafer W to them. Between the fourth processing unit group G4 and the fifth processing unit group G5, a second transfer unit A2 is provided, and a second transfer arm 11 for supporting and transferring the wafer W is provided in the second transfer unit A2. The second transfer arm 11 can selectively access the processing and treatment units in the second processing unit group G2, the fourth processing unit group G4, and the fifth processing unit group G5 and transfer the wafer W to them.

In the first processing unit group G1, as shown in FIG. 2, solution treatment units each for supplying a predetermined liquid to the wafer W to perform treatment, for example, resist coating units 20, 21, and 22 each for applying a resist solution as a coating solution to the wafer W, and bottom coating units 23 and 24 each for forming an anti-reflection film that prevents reflection of light at the time of exposure processing, are five-tiered in order from the bottom. In the second processing unit group G2, solution treatment units, for example, developing treatment units 30 to 34 each for supplying a developing solution to the wafer W to develop it are five-tiered in order from the bottom. Further, chemical chambers 40 and 41 each for supplying various kinds of treatment solutions to the solution treatment units in the processing unit groups G1 and G2 are provided on the lowermost tiers of the first processing unit group G1 and the second processing unit group G2, respectively.

As shown in FIG. 3, in the third processing unit group G3, the temperature regulating unit 60, the transition unit 61, high-precision temperature regulating units 62 to 64 each for temperature-regulating the wafer W under temperature control with a high precision, and high-temperature thermal processing units 65 to 68 each for heating the wafer W at a high temperature are nine-tiered in order from the bottom.

In the fourth processing unit group G4, for example, a high-precision temperature regulating unit 70, pre-baking units 71 to 74 each for performing heat processing on the wafer W after the resist coating treatment, and post-baking units 75 to 79 each for heat-processing the wafer W after the developing treatment, are ten-tiered in order from the bottom.

In the fifth processing unit group G5, a plurality of thermal processing units each for performing thermal processing on the wafer W, for example, high-precision temperature regulating units 80 to 83 and post-exposure baking units 84 to 89 are ten-tiered in order from the bottom.

As shown in FIG. 1, a plurality of processing and treatment units are arranged on the positive direction side in the X-direction of the first transfer unit A1, for example, adhesion units 90 and 91 each for performing hydrophobic treatment on the wafer W and heating units 92 and 93 each for heating the wafer W being four-tiered in order from the bottom as shown in FIG. 3. As shown in FIG. 1, on the positive direction side in the X-direction of the second transfer unit A2, for example, an edge exposure unit 94 is disposed which selectively exposes only the edge portion of the wafer W to light.

In the interface station 4, a wafer transfer body 101 moving on a transfer path 100 extending in the X-direction and a buffer cassette 102 are provided as shown in FIG. 1. The wafer transfer body 101 is movable in the Z-direction and also rotatable in the O-direction and thus can access the aligner (not shown) adjacent to the interface station 4, the buffer cassette 102, and the fifth processing unit group G5 and transfer the wafer W to them.

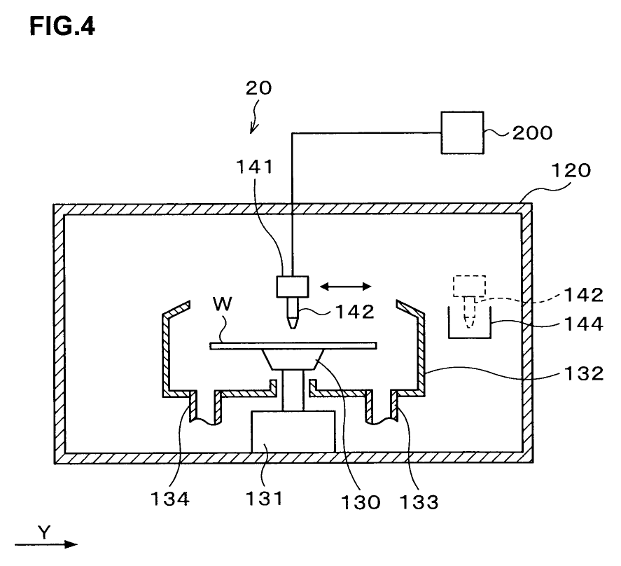

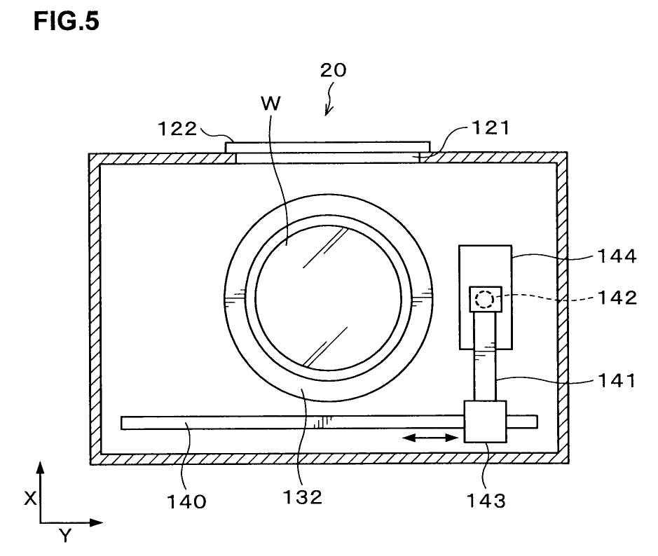

Next, the configurations of the above-described resist coating units 20 to 22 will be described. FIG. 4 is an explanatory view of a longitudinal section showing the outline of the configuration of the resist coating unit 20, and FIG. 5 is an explanatory view of a transverse section showing the outline of the configuration of the resist coating unit 20.

The resist coating unit 20 has a treatment container 120 whose inside can be closed as shown in FIG. 4. A side surface of the treatment container 120 facing a transfer-in region for the first transfer arm 10 is formed with a transfer-in/out port 121 for the wafer W as shown in FIG. 5, and an opening/closing shutter 122 is provided at the transfer-in/out port 121.

At a central portion in the treatment container 120, a spin chuck 130 for holding and rotating the wafer W is provided as shown in FIG. 4. The spin chuck 130 has a horizontal upper surface, and the upper surface is provided with, for example, a suction port (not shown) for sucking the wafer W. The suction through the suction port allows the wafer W to be held on the spin chuck 130.

The spin chuck 130 has a chuck drive mechanism 131 equipped with, for example, a motor or the like and can rotate at a predetermined speed by means of the chuck drive mechanism 131. Further, the chuck drive mechanism 131 is provided with a raising and lowering drive source such as a cylinder, so that the spin chuck 130 can vertically move.

Around the spin chuck 130, a cup 132 is provided which receives and collects liquid splashing or dropping from the wafer W. A drain tube 133 for draining the collected liquid and an exhaust tube 134 for exhausting the atmosphere in the cup 132 are connected to the bottom surface of the cup 132.

As shown in FIG. 5, on the side of the negative direction in the X-direction (the downward direction in FIG. 5), a rail 140 is formed which extends in a Y-direction (the right-to-left direction in FIG. 5). The rail 140 is formed, for example, from the outside on the negative direction side in the Y-direction of the cup 132 (the left direction in FIG. 5) to the outside on the positive direction side in the Y-direction (the right direction in FIG. 5). To the rail 140, an arm 141 is attached.

On the arm 141, a coating nozzle 142 for discharging the resist solution is supported as shown in FIG. 4 and FIG. 5. The arm 141 is movable on the rail 140 by means of a nozzle drive unit 143 shown in FIG. 5. This allows the coating nozzle 142 to move from a waiting section 144 provided at the outside on the positive direction side in the Y-direction of the cup 132 to a position above a central portion of the wafer W in the cup 132 and further move in a direction of the diameter of the wafer W above the front surface of the wafer W. The arm 141 freely rises and lowers by means of the nozzle drive unit 143 to be able to adjust the height of the coating nozzle 142. The coating nozzle 142 is connected to a resist solution supply apparatus 200 for supplying the resist solution as shown in FIG. 4.

Note that the configurations of the resist coating units 21 and 22 are the same as that of the above-described resist coating unit 21, and therefore description will be omitted.

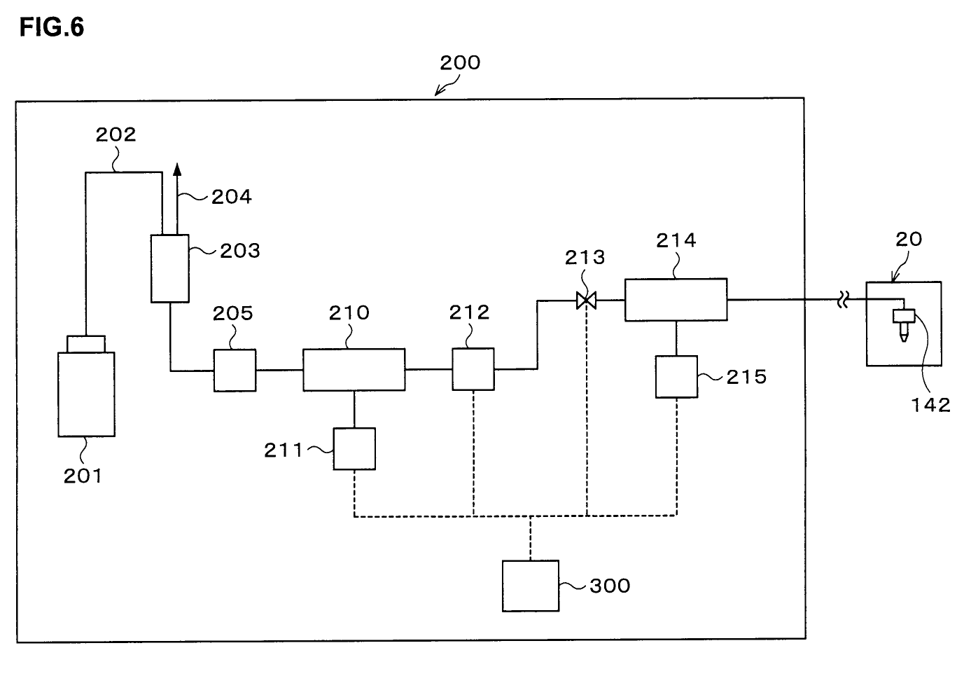

Next, a configuration of the resist solution supply apparatus 200 for supplying the resist solution to the coating nozzle 142 in the resist coating unit 20 will be described. FIG. 6 is an explanatory view showing the outline of the configuration of the resist solution supply apparatus 200. Note that the resist solution supply apparatus 200 is provided, for example, in the chemical chamber 40 shown in FIG. 2.

The resist solution supply apparatus 200 has a resist solution supply source 201 storing the resist solution. The resist solution is stored at room temperature, for example, 23° C. in the resist solution supply source 201. At an upper portion of the resist solution supply source 201, a supply tube 202 for supplying the resist solution to the coating nozzle 142 is provided. In other words, the supply tube 202 is laid between the resist solution supply source 201 and the coating nozzle 142.

The supply tube 202 downstream from the resist solution supply source 201 is provided with a liquid end tank 203 for temporarily storing the resist solution. At an upper portion of the liquid end tank 203, an auxiliary tube 204 for exhausting the atmosphere in the liquid end tank 203 is provided. The liquid end tank 203 serves as a buffer tank so that even when the resist solution to be supplied from the resist solution supply source 201 runs out, the resist solution stored in the liquid end tank 203 can be supplied to the coating nozzle 142.

The supply tube 202 downstream from the liquid end tank 203 is provided with a filter 205 for removing foreign matter in the resist solution. Note that the filter 205 can remove foreign matter other than resist gel in the resist solution.

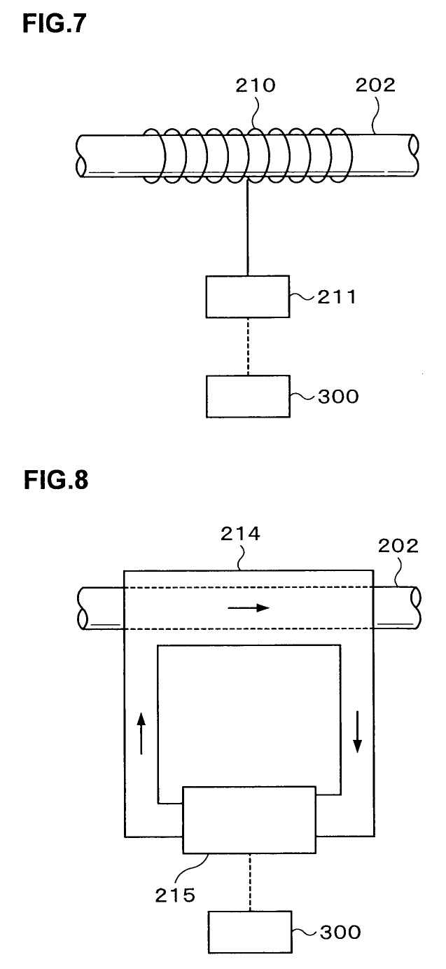

The supply tube 202 downstream from the filter 205 is provided with a heater 210 as a heating means for heating the resist solution in the supply tube 202. The heater 210 is spirally wound around the outer periphery of the supply tube 202 as shown in FIG. 7. The heater 210 is provided with a temperature regulator 211 for regulating the heating temperature of the heater 210. Setting of the heating temperature of the heater 210 by the temperature regulator 211 is controlled by a later-described control unit 300.

The heating temperature by the heater 210 is set by the temperature regulator 211 to a temperature higher than 23° C. that is room temperature, more preferably 30° C. or higher. By setting the heating temperature to a temperature higher than room temperature as described above, the resist solution in the supply tube 202 is set to a temperature higher than room temperature, so that the resist gel can be dissolved in the resist solution. Further, the heating temperature by the heater 210 is set to 50° C. or lower. By setting the maximum heating temperature to 50° C. or lower as described above, the resist solution never deteriorates in quality. Note that the maximum heating temperature by the heater 210 is set at 40° C. in this embodiment.

The supply tube 202 downstream from the heater 210 is provided with a pump 212 for pressure-feeding the resist solution from the resist solution supply source 201 to the coating nozzle 142 as shown in FIG. 6. For the pump 212, for example, a tubephragm-type pump is used. The operation of the pump 212 is controlled, for example, by the later-described control unit 300.

The supply tube 202 downstream from the pump 212 is provided with a valve 213. For the valve 213, for example, an air-operation valve is used. The opening/closing operation of the valve 213 is controlled by control of the later-described control unit 300 such that the supply of the resist solution from the pump 212 to the coating nozzle 142 can be started or stopped.

The supply tube 202 downstream from the valve 213 is provided with temperature regulating piping 214 as a cooling means for cooling the resist solution in the supply tube 202. The temperature regulating piping 214 is provided to surround the outer periphery of the supply tube 202 as shown in FIG. 8. Inside the temperature regulating piping 214, temperature regulating water flows and, for example, pure water is used for the temperature regulating water. The temperature regulating piping 214 is connected to a temperature regulator 215 for regulating the temperature of the temperature regulating water. The temperature setting of the temperature regulating water in the temperature regulating piping 214 by the temperature regulator 215 is controlled by the later-described control unit 300.

The cooling temperature by the temperature regulating water in the temperature regulating piping 214 is set to cool the resist solution in the supply tube 202 such that the temperature of the resist solution is 23° C. that is room temperature. Then, the temperature regulating water in the temperature regulating piping 214 regulates the temperature of the resist solution to 23° C. via the supply tube 202, and is then sent to the temperature regulator 215 and temperature-regulated again by the temperature regulator 215 and used for temperature regulation of the resist solution in the supply tube 202.

The setting of the heating temperature of the heater 210 by the temperature regulator 211, the drive operation of the pump 212, the opening/closing operation of the valve 213, and the temperature setting of the temperature regulating water in the temperature regulating piping 214 by the temperature regulator 215 which are described above are controlled by the control unit 300. The control unit 300 is composed of, for example, a computer including a CPU and a memory, and can realize the supply of the resist solution by the resist solution supply apparatus 200 and the resist coating treatment in the resist coating unit 20, for example, by executing programs stored in the memory. Note that various programs used for realizing the supply of the resist solution by the resist solution supply apparatus 200 and the resist coating treatment in the resist coating unit 20 are ones that are recorded, for example, on a storage medium (not shown) such as a computer-readable hard disk (HD), flexible disk (FD), compact disk (CD), magneto-optical disk (MO), or a memory card, and installed from the storage medium into the control unit 300.

Next, the supply of the resist solution to the coating nozzle 142 performed in the resist solution supply apparatus 200 configured as described and the coating treatment process performed in the resist coating unit 20 will be described together with the process of the wafer processing performed in the coating and developing treatment system 1.

First of all, one wafer W is taken out of the cassette C on the cassette mounting table 5 by the wafer body 7 and transferred to the temperature regulating unit 60 in the third processing unit group G3. The wafer W transferred to the temperature regulating unit 60 is temperature-regulated to a predetermined temperature, and then transferred by the first transfer arm 10 to the bottom coating unit 23, where an anti-reflection film is formed. The wafer W on which the anti-reflection film has been formed is transferred by the first transfer arm 10 to the heating unit 92, the high-temperature thermal processing unit 65 and the high-precision temperature regulating unit 70 in sequence, and subjected to predetermined processing in each of the units. The wafer W is then transferred to the resist coating unit 20. Note that the coating treatment of the resist solution in the resist coating unit 20 will be described later.

After the resist film is formed on the wafer W in the resist coating unit 20, the wafer W is transferred by the first transfer arm 10 to the pre-baking unit 71 and subjected to heat processing. Subsequently, the wafer W is transferred by the second transfer arm 11 to the edge exposure unit 94 and the high-precision temperature regulating unit 83 in sequence to be subjected to predetermined processing in each of the units. The wafer W is then transferred by the wafer transfer body 101 in the interface station 4 to the aligner (not shown) where a predetermined pattern is exposed on the resist film on the wafer W. The wafer W for which the exposure processing has been completed is transferred by the wafer transfer body 101 to the post-exposure baking unit 84 and subjected to predetermined processing.

After the thermal processing in the post-exposure baking unit 84 is completed, the wafer W is transferred by the second transfer arm 11 to the high-precision temperature regulating unit 81 and temperature-regulated, and then transferred to the developing treatment unit 30 where developing treatment is performed on the wafer W, whereby a pattern is formed in the resist film. The wafer W is then transferred by the second transfer arm 11 to the post-baking unit 75 and subjected to heat-processing, and then transferred to the high-precision temperature regulating unit 63 and temperature-regulated. The wafer W is transferred by the first transfer arm 10 to the transition unit 61 and then returned by the wafer transfer body 7 to the cassette C, with which a series of photolithography process ends.

Next, a series of resist coating treatment of supplying the resist solution from the resist solution supply apparatus 200 to the coating nozzle 142 in the resist coating unit 20 and applying the resist solution to the wafer W in the resist coating unit 20 will be described.

First, the valve 213 is opened and the pump 212 is operated by the control unit 300. Then, the resist solution is pressure-fed from the resist solution supply source 201 to the liquid end tank 203. The resist solution is temporarily stored in the liquid end tank 203. Once a predetermined mount of resist solution is stored in the liquid end tank 203, the resist solution flows out of the liquid end tank 203 toward the coating nozzle 142 by the resist solution subsequently flowing from the resist solution supply source 201 into the liquid end tank 203.

After the resist solution starts to flow out of the liquid end tank 203, the heater 210 is operated to heat up to 40° C., and the temperature regulating water which has been temperature-regulated to a predetermined temperature is flowed through the temperature regulating piping 214. Note that the wafer W is carried into the resist coating unit 20 at this moment.

The resist solution flows out of the liquid end tank 203 then passes through the filter 205, whereby the foreign matter other than the resist gel in the resist solution is removed. The resist solution then flows to the supply tube 202 provided with the heater 210. In this event, the resist solution is heated up to 40° C. by the heater 210. Thus, the resist gel which could not be removed by the filter 205 dissolves in the resist solution.

The resist solution then flows through the pump 212 and the valve 213 to the supply tube 202 provided with the temperature regulating piping 214. In this event, the resist solution is cooled down to 23° C. by the temperature regulating water in the temperature regulating piping 214. In this manner, the resist solution cooled down to 23° C. is supplied to the coating nozzle 142.

When the resist solution is supplied to the coating nozzle 142, the wafer W held on the spin chuck 130 by suction is rotated by the chuck drive mechanism 131 in the resist coating unit 20, and the resist solution is dripped from the coating nozzle 142 onto a central portion of the wafer W. The resist solution applied to the wafer W diffuses over the entire front surface of the wafer W by the centrifugal force generated by the rotation of the wafer W, whereby a resist film is formed on the front surface of the wafer W. Thereafter, the rotation of the wafer W is sopped, and the wafer W is transferred out from the top of the spin chuck 130, with which a series of the resist coating treatment ends.

According to the above embodiment, the resist solution in the supply tube 202 is heated by the heater 210 to 40° C., so that the resist gel in the resist solution can be dissolved. This can reduce the resist gel in the resist solution to be discharged from the coating nozzle 142 onto the wafer W. Accordingly, defects on the wafer W after application of the resist solution can be reduced to improve the yields of the wafer W as a product.

According to the above embodiment, the resist solution in the supply tube 202 can be heated to 40° C. by the heater 210 and thereafter can be cooled down to 23° C. by the temperature regulating water in the temperature regulating piping 214. Accordingly, the resist solution temperature-regulated at 23° C. can be discharged from the coating nozzle 142 onto the wafer W, so that the thickness of the resist film formed on the wafer W can be made uniform.

Since the supply tube 202 upstream from the heater 210 is provided with the filter 205, the foreign matter in the resist solution can be removed before the resist solution is heated by the heater 210. Further, since the filter 205 is provided upstream from the heater 210, the heated resist solution never passes through the filter 205, thereby preventing the filter 205 from deteriorating due to the heat.

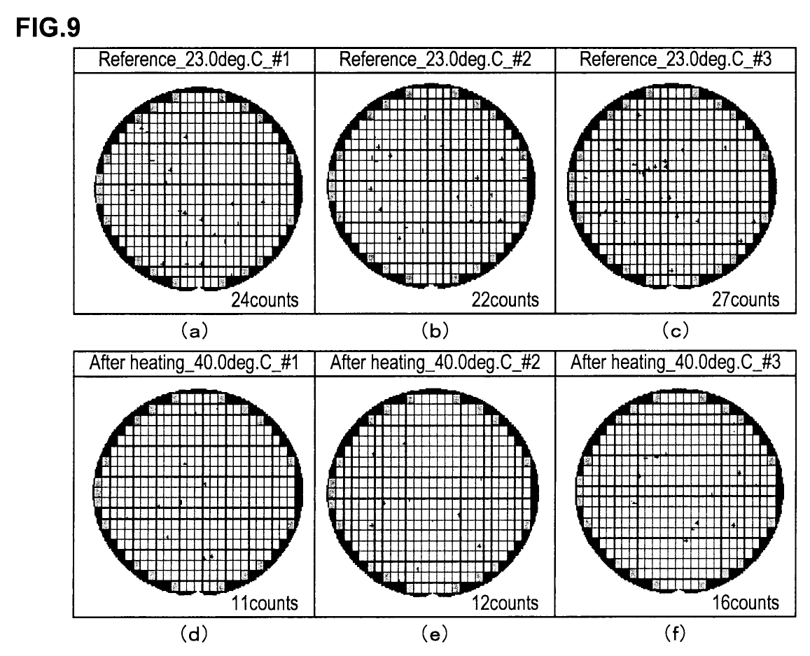

Here, results of verification conducted by the inventors about the effect of the above-described reduction of defects on the wafer W are shown in FIG. 9. FIG. 9 shows the defects on the wafers W and the numbers of defects when a series of photolithography processing was performed on the wafers W using the coating and developing treatment system 1 to form predetermined resist patterns on the wafers. (a) to (c) in FIG. 9 show verification results in a case where the heat processing of the resist solution was not performed but the resist solution temperature-regulated to 23° C. by a conventional method was supplied to the coating nozzle 142. These verification results are those when the same processing was performed on three different wafers. According to the verification results, the numbers of defects on the wafers W were 24 to 27. (d) to (f) in FIG. 9 show verification results in a case where the resist solution was heated up to 40° C. and then cooled down to 23° C. by the method according to this embodiment and was supplied to the coating nozzle 142. These verification results are those when the same processing was performed on three different wafers. According to the verification results, the numbers of defects on the wafers W were 11 to 16. Consequently, it was found that when the resist solution is supplied using the method according to this embodiment, the number of defects on the wafer W can be reduced by about 50% from that in the prior art.

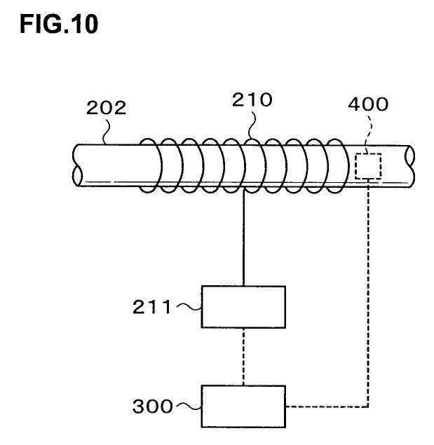

In the supply tube 202 provided with the heater 210 in the above embodiment, a temperature sensor 400 for measuring the temperature of the resist solution heated by the heater 210 may be provided as shown in FIG. 10. In this case, the temperature sensor 400 is provided near an end portion on the downstream side of the heater 210. The measurement result measured by the temperature sensor 400 is then outputted to the control unit 300. The control unit 300 monitors the temperature measurement result of the heated resist solution and can control the setting of the heating temperature of the heater 210 in the temperature regulator 211 based on the measurement result. Thus, the resist solution can be heated at a fixed temperature at all times.

Though the heater 210 is used as the heating means in the embodiment, temperature regulating piping (not show) through which a temperature regulating water flows may be used as a heater heating means. In this case, a temperature regulator (not shown) is connected to the temperature regulating piping so that the temperature of the temperature regulating water is regulated by the temperature regulator. Then, the temperature regulating water heated to a predetermined temperature is flowed through the temperature regulating piping, whereby the resist solution in the supply tube 202 can be heated to 40° C. Note that the configurations of the temperature regulating piping and the temperature regulator are the same as those of the temperature regulating piping 214 as the above-described cooling means and the temperature regulator 215.

Though the heater 210 is used as the heating means in the embodiment, a microwave irradiation device (not show) for applying microwave to the supply tube 202 may be used. In this case, the microwave irradiation device is connected to the control unit 300 so that the wavelength, the irradiation time and so on of the microwave applied from the microwave irradiation device are controlled by the control unit 300. Then, by applying a predetermined microwave from the microwave irradiation device to the supply tube 202, the resist solution in the supply tube 202 can be heated to 40° C.

Though the resist solution in the supply tube 202 is cooled to 23° C. in the cooling means 214 in the embodiment, the resist solution may be cooled to a temperature higher than 23° C., for example, 28° C. In this case, the resist solution at 28° C. is discharged from the coating nozzle 142 to the wafer W. Thus, in subsequently forming a resist film in the resist coating unit 20 by rotating the wafer W to diffuse the resist solution, the drying time of the resist film can be reduced. This can improve the throughout of the wafer processing.

Through the case in which the resist solution is supplied to the coating nozzle 142 has been described in the embodiment, the present invention is also effective in a case of supplying a treatment solution containing a polymer-based compound other than the resist solution. More specifically, even when the polymer-based compound aggregates with time to generate a gel foreign matter in the treatment solution, the gel foreign matter can be dissolved in the treatment solution by heating the treatment solution once. Then, by cooling the treatment solution again, the treatment solution at a predetermined temperature can be supplied.

A preferred embodiments of the present invention has been described above with reference to the accompanying drawings, but the present invention is not limited to the embodiment. It should be understood that various changes and modifications are readily apparent to those skilled in the art within the scope of the spirit as set forth in claims, and those should also be covered by the technical scope of the present invention. The present invention is not limited to the embodiment but can take various forms. The present invention is also applicable to the case where the substrate is substrates other than the wafer, such as an FPD (Flat Panel Display), a mask reticle for a photomask, and the like.

The present invention is useful in supplying a resist solution to a coating nozzle for discharging the resist solution to a substrate, for example, a semiconductor wafer or the like.

What is claimed is:

1. A resist solution supply apparatus for supplying a resist solution to a coating nozzle for discharging the resist solution to a substrate, comprising:
a resist solution supply source storing the resist solution therein;
a supply tube for supplying the resist solution from said resist solution supply source to said coating nozzle;
a heating means provided on a side of said resist solution supply source along said supply tube for heating the resist solution in said supply tube to a predetermined temperature higher than room temperature; and
a cooling means provided on a side of said coating nozzle along said supply tube for cooling the resist solution in said supply tube down to room temperature.

2. The resist solution supply apparatus as set forth in claim 1,
wherein said supply tube is provided with a filter for removing foreign matter in the resist solution.

3. The resist solution supply apparatus as set forth in claim 2,
wherein said filter is provided on a side closer to said resist solution supply source than said heating means.

4. The resist solution supply apparatus as set forth in claim 1,
wherein said supply tube provided with said heating means is provided with a temperature sensor for measuring a temperature of the resist solution in said supply tube, and
wherein said apparatus includes a control unit for controlling a heating temperature of said heating means based on a measurement result by said temperature sensor.

5. The resist solution supply apparatus as set forth in claim 1,
wherein the room temperature of the resist solution is 22-24° C., and
wherein said heating means is capable of heating the resist solution at 22-24° C. to 30-50° C.

6. A resist solution supply method of supplying a resist solution to a substrate, comprising:
a heating step of once heating the resist solution up to a predetermined temperature higher than room temperature;
then, a cooling step of cooling the resist solution down to room temperature; and
then, a step of supplying the resist solution to the substrate.

7. The resist solution supply method as set forth in claim 6,
wherein the room temperature of the resist solution is 22-24° C., and
wherein the resist solution at 22-24° C. is once heated to 30-50° C. in said heating step.

8. A computer-readable storage medium storing a program running on a computer of a control unit for controlling a resist solution supply apparatus to cause the resist solution supply apparatus to execute a resist solution supply method of supplying a resist solution to a substrate,
said resist solution supply method, comprising the steps of:
a heating step of once heating the resist solution up to a predetermined temperature higher than room temperature;
then, a cooling step of cooling the resist solution down to room temperature; and
then, a step of supplying the resist solution to the substrate.
